(19) United States
(12) Patent Application Publication
(10) Pub. No.: US 2024/0336096 A1
(43) Pub. Date: Oct. 10, 2024

(54) TRAILER TOWING APPARATUS

(71) Applicant: RED AUTOMOTIVE TECHNOLOGIES PTY LTD, Brompton (AU)

(72) Inventors: Paul VAN DE LOO, Norton Summit (AU); Ryan SCHULZ, Prospect (AU)

(73) Assignee: RED AUTOMOTIVE TECHNOLOGIES PTY LTD, Brompton, SA (AU)

(21) Appl. No.: 18/575,701

(22) PCT Filed: Jun. 30, 2022
(86) PCT No.: PCT/AU2022/050679

§ 371 Date: Dec. 29, 2023

(30) Foreign Application Priority Data
Jun. 30, 2021 (AU) 2021901978

(51) Int. Cl. B60D 1/167; B60D 1/30

(52) U.S. Cl. CPC B60D 1/167; B60D 1/30

(57) ABSTRACT

Apparatus for connecting a trailer 20 to a vehicle for towing. The apparatus comprises: a vehicle-trailer coupling including a vehicle coupling 1a and a trailer coupling 1b and having a vertical centreline X; and a switchable yaw pivot 2. The switchable yaw pivot 2 is switchable between locked and unlocked positions. In the unlocked position movement of one part 3 of the apparatus relative to a remaining part of the apparatus about the switchable yaw pivot 2 is permitted in order to align the vehicle coupling 1a with the trailer coupling 1b to assist with coupling. In the locked position movement about the switchable yaw pivot 2 is not permitted after coupling and once the vehicle and trailer are aligned. When the switchable yaw pivot is locked, relative yaw movement between the vehicle and the trailer is only possible about the virtual yaw pivot Y.

### CROSS REFERENCES TO RELATED APPLICATIONS

This application is a national stage filing under section 371 of International Application No. PCT/AU2022/050679, filed on Jun. 30, 2022, and published on Jan. 5, 2023, as WO 2023/272354, which claims priority to Australian Patent Application No. 2021901978, filed on Jun. 30, 2021. The entire contents of each application are incorporated herein by reference in their entireties.

### TECHNICAL FIELD OF THE INVENTION

The present invention relates to apparatus for connecting a towing vehicle to a towed vehicle, which will hereafter simply be referred to as apparatus for the towing of a “trailer” behind a “vehicle”.

### BACKGROUND OF THE INVENTION

Trailers are commonly towed by vehicles on and off road. Typical on-road applications for trailers are caravans, horse floats and general goods carrying trailers towed behind passenger vehicles. Trailers are also often towed behind trucks, greatly increasing their load transportation ability.

Before continuing with a background description, and to ensure consistency in the language used throughout this specification, it should be understood that terms designating direction, such as forward and aft, will be used throughout this specification in the context of a vehicle-trailer combination on a roadway travelling in a normal direction, that is with the vehicle forward of the trailer.

Other terms such as roll, pitch and yaw are then used throughout this specification in the conventional context commonly used for vehicles, with the roll axis being aligned with the direction of straight-ahead travel or the longitudinal axis of the vehicle, the pitch axis being the axis perpendicular to this in the horizontal plane, and the yaw axis being mutually orthogonal to these, namely being the turning axis or vertical axis. In general, there are of course six independent degrees of freedom in which an object can move, being three in translation along the mutually orthogonal pitch, roll and yaw axes, and three in rotation about the pitch, roll and yaw axes.

In this specification, unless stated to the contrary, the reference frame for all terms used to describe motion of both a vehicle and a trailer in all six degrees of freedom, including fore/aft, roll, pitch and yaw, will be the vehicle. This is important to appreciate as when the trailer deviates in its orientation from that of the vehicle, it must be clear which reference frame motion is being described in.

The towing of trailers has risks associated with it. There are modes of instability of a vehicle and trailer combination that can lead to a loss of control and accidents. A key one is often referred to as “snaking” or “sway”, which consists of yaw oscillations of the vehicle and trailer, with the yaw of each in counter phase.

Despite research into vehicle-trailer dynamic behaviour spanning many decades, tow hitches used in most towing apparatus have seen no fundamental changes over this period and snaking continues to be an issue. While modern vehicle and trailer electronic stability control systems can be effective at mitigating the snaking motion by applying wheel brakes, they presently cannot prevent its onset.

Tow hitches used on passenger vehicles typically consist of a ball joint comprising a tow ball on a tow bar on the rear of the vehicle and a female receiver on the trailer. Other tow hitches separate the rotation axes into separate pivots, but the centre of rotation of each rotation axis is typically located at or near the same point, and at basically the same location, as a ball joint type hitch. Having the centre of yaw rotation of a trailer at the position of a tow ball, which is rearwards of the rear axle of the vehicle (often referred to as an “overhung” hitch), can be undesirable for the stability of the vehicle-trailer combination.

Overhung hitches tend to be the only option for wagon and sedan type vehicles where it is not possible to have a hitch above the rear axle, such as a fifth-wheel arrangement that can be used with pick-up trucks and the like. With overhung hitches, the hitch is thus usually situated on a vehicle tow bar mounted to the rear face of the vehicle. The tow ball for such an arrangement is then typically mounted just aft of the rear face of the vehicle, the rear face being defined as a vertical plane coincident with the rearmost extremity of the vehicle body work or chassis, such as (typically) the rear bumper bar. The tow ball is mounted just aft (typically less than 250 mm) because to mount it further rearwards provides no advantage but poses problems with obstruction to pedestrians and causing collisions with other vehicles.

It is an aim of the present invention to provide an improved apparatus for connecting a trailer to a vehicle for towing the trailer behind the vehicle.

Any description of prior art is provided merely as background to explain the context of the invention. It is not to be taken as an admission that any of the material referred to was published or known or was a part of the common general knowledge in Australia or elsewhere.

### SUMMARY OF INVENTION

In one aspect there is provided an apparatus for connecting a trailer to a vehicle for towing, the apparatus comprising:
a vehicle-trailer coupling including a vehicle coupling and a trailer coupling and having a vertical centreline; and
a switchable yaw pivot;
wherein the switchable yaw pivot is switchable between an unlocked position, where movement in yaw of one part of the apparatus relative to a remaining part of the apparatus about the switchable yaw pivot is permitted, and a locked position, where movement the one part of the apparatus relative to the remaining part of the apparatus about the switchable yaw pivot is not permitted.

In one embodiment the apparatus includes a mechanical linkage that generates a virtual yaw pivot and that is configured to permit relative movement between the vehicle and the trailer about at least a yaw axis; and wherein the mechanical linkage is configured to constrain the location of the virtual yaw pivot to be, in use, at or forward of the vertical centreline of the vehicle-trailer coupling, at least for small yaw angles.

In one embodiment the switchable yaw pivot includes: a block coupled to or forming part of the mechanical linkage and a pivot pin pivotally coupling the block to the vehicle-trailer coupling; and a locking mechanism for releasably locking the block from movement about the pivot pin relative to vehicle-trailer coupling.

In one embodiment the vehicle-trailer coupling includes a ball and socket and the switchable yaw pivot includes: a circumferential groove formed in the ball and lying in a plane containing the centreline; and a locking mechanism for releasably engaging and disengaging the groove, wherein yaw movement between the trailer coupling and the vehicle coupling is prevented then the locking mechanism is engaged with groove.

Different components of the apparatus of the present invention will now be described, commencing with the mechanical linkage. The mechanical linkage may take many different physical forms. The purpose and function of the mechanical linkage is to provide a virtual pivot axis for the motion of one bar of the linkage relative to an opposing bar. Mechanical linkages can thus provide a virtual pivot in a location where a physical pivot cannot be placed, for example due to other components needing to reside at that location. Typically, such a virtual pivot location will not be fixed, but will move as the mechanical linkage moves. In this respect, the term “virtual pivot” or “virtual yaw pivot” as used throughout this specification will sometimes be referred to as an “instantaneous centre of rotation” or “an instantaneous yaw centre”, again implying that the centre (or pivot) is moving but is located at that point at that instant of the motion of the mechanical linkage. One example of a mechanical linkage suitable for incorporation in embodiments of the disclosed apparatus is the four-bar linkage. A four-bar linkage is inherently able to provide a virtual pivot axis for the motion of a bar relative to its opposing bar.

In embodiments of the present invention, it may not be readily apparent, what constitutes each member or bar in a mechanical linkage. For example, in some embodiments, the vehicle or trailer will itself form one bar. In some forms, a first bar will be the trailer itself, but in other forms this first bar will be at least semi-rigidly connected to the trailer. Further, a fourth, or opposing, bar may in some forms be the vehicle itself, but in other forms will similarly be a bar semi-rigidly connected to the vehicle.

The terms “semi-rigid” and “semi-rigidly” are used in this specification to describe connections that constrain one part against movement relative to another part in most but not all degrees of freedom. For example, a preference for the first and/or fourth bars to be connected semi-rigidly to the trailer or vehicle respectively arises from the need to provide relative roll and pitch motion between the vehicle and the trailer, which is explained further below. In this context, the term “semi-rigid” thus means constrained against movement in all degrees of freedom other than rotation in roll and/or pitch. In this particular example, such semi-rigid connection may be via one or more intermediate structural members, or may be via another mechanical linkage.

On the other hand, where there is reference to “rigid” or “rigidly” in this specification, this will be a reference to connections that do not allow any significant movement between the parts in any of the six degrees of freedom.

Ordinarily, all bars of a mechanical linkage including the four-bar linkage will lie substantially in a horizontal plane such as to provide an axis of rotation of the trailer about the vehicle that is substantially aligned with the axis normal to this plane, namely the yaw axis. This allows the trailer to rotate about the vehicle, such as is required to facilitate negotiation of a curve in a roadway by the vehicle-trailer combination. In this respect, the term “horizontal” is used at times in this specification in an inexact sense, in that it is used to describe the plane of the roadway, whether inclined or not. Similarly, the term “vertical” is used to define the axis perpendicular to the roadway, again whether the roadway is inclined or not.

The word “bar” used in the terms mechanical linkage or four-bar linkage also requires some explanation. In its most basic form, a bar is a simple straight connecting rod with a pivot at each end that connects to adjacent bars, and is thus essentially one-dimensional. However, in embodiments of the present invention bars need not always take this form. Indeed, bars may have any three-dimensional shape. For example, a bar may in some embodiments be a bar in more than one four-bar linkage, such as the case where two four-bar linkages in orthogonal planes share one or more bars. In this case, a simple connecting bar may still be one-dimensional, whilst bars that connect to more than two bars would be at least two-dimensional. However, it should be appreciated that any three-dimensional shape could also be adopted.

Before turning to a discussion of the possible locations of the virtual yaw pivot of the mechanical linkage, it will be appreciated that a preference for any apparatus used for connecting a trailer to a vehicle for towing is for it to provide for ease of connection, or “hitching” or “coupling”, of the trailer to the vehicle. Typically, such connection is performed by reversing a vehicle up to a trailer such that the two align and can be connected. For the purposes of this specification, the component or portion of the vehicle-trailer coupling affixed to, or integral with, the vehicle is herein termed the “vehicle coupling” and the component or portion affixed to, or integral with, the trailer is termed the “trailer coupling”.

As mentioned above, the location of the virtual yaw pivot will tend to vary with relative motion between the bars in the mechanical linkage. In terms of the provision of improved stability of a vehicle and trailer combination, when travelling at speed, and travelling substantially in a straight line, it has been determined that the location of the pivot point of the trailer about the vehicle in the horizontal plane (namely, the yaw pivot), advantageously lies at or forward of the vertical centreline of a vehicle-trailer coupling. In one embodiment, when the mechanical linkage is a four-bar linkage, the four-bar linkage will be configured to provide this by placing the intersection point of the axes of the two connecting bars forward of the bar connected to the vehicle (the fourth bar).

With this in mind, when this specification refers to a location for the virtual yaw pivot as being “at or forward of the vertical centreline of the vehicle-trailer coupling”, it will be appreciated that this centreline is a notional line located geometrically centrally through the combined vehicle coupling and trailer coupling. For example, if the vehicle-trailer coupling is a traditional tow-bar/tow-ball arrangement, there will be a vertical centreline through the centre of the ball. For other couplings, particularly those that are not symmetrical in the fore-aft direction, the centreline contains the mid-point between the fore-most and aft-most contact points between the vehicle and trailer couplings.

For the same reasons as described above with respect to traditional tow bars, the centreline of the vehicle coupling in embodiments of the present invention will typically be located just aft (i.e., within say 250 mm) of the rear face of a vehicle. In other embodiments, the location of the virtual yaw pivot will lie at or forward of that rear face, the rear face being defined as a vertical plane coincident with the rearmost extremity of the vehicle (body work or chassis), such as (typically) the rear bumper bar. In yet another form of the invention, the location of the virtual yaw pivot will lie at or forward of the vehicle rear axle, again at least when the vehicle and trailer are aligned. While the distance from the rear face of a vehicle to its rear axle will vary from vehicle to vehicle, the virtual yaw pivot can be placed far enough forward of the vehicle-trailer coupling so that it at least approaches the rear axle for many vehicles.

With reference now to other aspects of the apparatus, it will be appreciated that when a vehicle towing a trailer is negotiating undulating terrain, the trailer will need to rotate about the pitch axis relative to the vehicle. This requires a pitch pivot that enables embodiments of the apparatus to permit relative rotation between the vehicle and the trailer about the pitch axis. This may be provided by allowing for one bar to rotate in pitch relative to the vehicle. In one form, this may be provided by allowing for the fourth bar to rotate in pitch relative to the vehicle. In another form, this may be provided by allowing for the first bar to rotate relative to the trailer about the pitch axis. In yet another form, the mechanical linkage may allow this rotation within it by incorporating ball joints rather than simple pivots at two or more joints. In some embodiments, the mechanical linkage may include a second four-bar linkage, arranged such that its bars lie in substantially the vertical fore-aft plane, and which may comprise the pitch pivot.

Similarly, it will be appreciated that when a vehicle towing a trailer is negotiating a roadway with varying camber, or when cornering forces are experienced, resulting in differing amounts of body roll on the vehicle and trailer combination, the trailer will need to rotate about the roll axis relative to the vehicle. This requires a roll pivot that enables embodiments of the apparatus to permit relative rotation between the trailer and the vehicle about the roll axis. This may be provided by allowing for one bar to rotate in roll relative to the vehicle. In one form, this may be provided by allowing for a bar to rotate in roll relative to the vehicle. In another form, this may be provided by allowing for the first bar to rotate relative to the trailer about the roll axis. In yet another form, the mechanical linkage may again allow this rotation within it by incorporating ball joints rather than simple pivots or pinned joints.

The vehicle-trailer coupling of course will ideally provide a secure connection between the vehicle and trailer. To facilitate the virtual pivot function of the mechanical linkage, and to provide such a secure connection, the vehicle-trailer coupling should be rigid in all three translation degrees of freedom, namely along each of the pitch axis, the roll axis and the yaw axis, and also rigid in yaw motion (namely, about the yaw axis). In one embodiment though, the vehicle-trailer coupling may provide relative pitch motion (namely, about the pitch axis). In another form, it may provide relative roll motion. In yet another form, it may provide both roll and pitch motion. In yet another form, it will provide no relative motion at all, but will be locked in all six degrees of freedom.

By way of explanation, it will be appreciated that typically, when a driver reverses a vehicle up to the front of a trailer, the vehicle will not be perfectly aligned with the trailer, particularly laterally and rotationally about the yaw axis. The mechanical linkage incorporated in embodiments of the apparatus provides for the trailer coupling to be translated laterally to align it, but this will have the effect of rotating the trailer coupling in yaw. It can thus be very difficult for a driver to achieve alignment both laterally and in yaw between vehicle and trailer couplings.

Embodiments of the apparatus thus include a switchable yaw pivot, such that when the switch is unlocked the trailer coupling can be rotated in yaw such that it can be aligned with the vehicle coupling. On completion of coupling, and once the vehicle and trailer are aligned, the switchable yaw pivot can then be locked by the driver such that the effective yaw rotation axis of the trailer about the vehicle is provided only by the mechanical linkage and no longer by the switchable yaw pivot.

In embodiments of the apparatus the switchable yaw pivot will switch to the locked state automatically on the vehicle pulling the trailer into the straight-ahead direction, thus aligning the trailer with the vehicle. In one form, the switchable yaw pivot must be held in its unlocked position by the driver and will, under the influence of a spring or the like, revert to the locked position as soon as the driver releases it and the lock is aligned. This ensures that the vehicle cannot tow the trailer with the yaw pivot in the unlocked state, once the trailer has aligned with the vehicle's direction of travel.

Embodiments of the apparatus may also incorporate a load compensating (or balancing) spring to provide for ease of connecting a trailer coupling to a vehicle coupling. In a preferred form, a load compensating spring is adapted to carry the weight of the portion of the apparatus forward of the pitch pivot. In this form, the need for a user, who is connecting the couplings, to have to lift the weight of this portion to raise it to the level of the vehicle coupling is obviated.

Before turning to a description of several specific embodiments, it will also be appreciated that for many users, apparatus that incorporates a load distribution system, or the sensing of vehicle braking and the actuation of trailer brakes, will be desirable. Such functions may of course also be incorporated within the embodiments of the apparatus.

Finally, embodiments of the apparatus may additionally incorporate a jockey wheel that can be used to support the weight normally carried by the trailer coupling when the trailer is decoupled from the vehicle.

### BRIEF DESCRIPTION OF DRAWINGS

Embodiments of the apparatus will now be described by way of example only with reference to the accompanying drawings. However, it is to be understood that the following description is not to limit the generality of the above description.

In the drawings:

FIG. 1 is a schematic diagram illustrating a first embodiment of the apparatus showing a side view;

FIG. 2 is a schematic diagram again of the first embodiment, showing a plan view;

FIG. 3 is a plot showing how the virtual yaw pivot point moves with yaw angle;

FIG. 4 is a schematic diagram illustrating a second embodiment of the apparatus, showing a side view;

FIG. 5 is a schematic diagram again of the second embodiment of the apparatus, showing a plan view;

FIG. 6 is a schematic diagram illustrating a third embodiment of the apparatus, showing a side view;

FIG. 7 is a schematic diagram again of the third embodiment of the apparatus, showing a plan view.

FIG. 8 is a schematic diagram illustrating a fourth embodiment of the apparatus, showing a side view;

FIG. 9 is a schematic diagram again of the fourth embodiment of the apparatus, showing a plan view;

FIG. 10 is a partial view of the fourth embodiment in operation;

FIG. 11 is another partial view of the fourth embodiment in operation;

FIG. 12 is a schematic diagram illustrating a fifth embodiment of the apparatus, showing a side view;

FIG. 13 is a schematic diagram again of the fifth embodiment of the apparatus, showing a plan view; and

FIGS. 14 to 18 are schematic diagrams illustrating a sixth embodiment of the apparatus, where FIG. 14 shows a perspective view from above, FIGS. 15 and 16 show a section view and a close-up section view, respectively, of the embodiment, FIG. 17 shows a perspective view from above, but from the other side, and FIG. 18 shows a close-up view of one portion of the apparatus.

### DETAILED DESCRIPTION OF SPECIFIC EMBODIMENTS

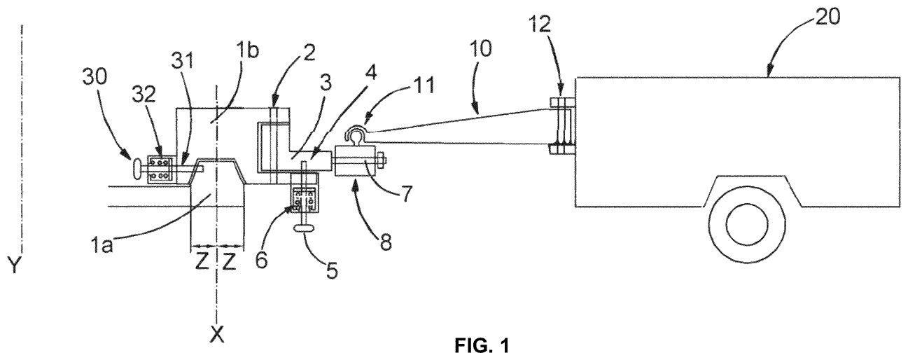

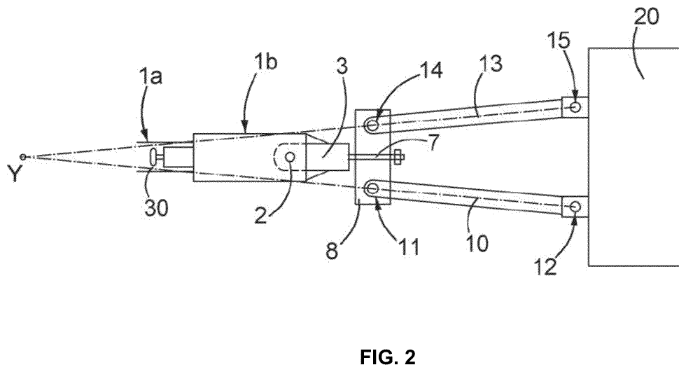

In the embodiment of the apparatus shown in FIGS. 1 and 2 the switchable yaw pivot is used in conjunction with a mechanical linkage in the form of a four-bar linkage. The first bar of a four-bar linkage is formed by the body of a trailer 20. The second and third bars (10,13) are connected to the trailer 20 via pivot pins (12,15) that provide for relative motion about only a substantially vertical axis. The bars (10,13) are of equal length and are arranged symmetrically about the fore-aft centreline when the vehicle (not shown) and the trailer 20 are travelling straight ahead. The other ends of the bars (10, 13) are connected to the fourth bar 8 via ball joints (11,14), each providing relative motion in all three degrees of rotational freedom. These two ball joints (11,14) thereby provide a pitch pivot between the vehicle and the trailer 20.

In this embodiment, the pitch pivot and the four-bar linkage are thus coincident in that some components, namely the ball joints (11,14), are common between them and these components have a dual function in that they play a role in the four-bar linkage as well as in the pitch pivot.

All four bars in the four-bar linkage of this embodiment lie in substantially the horizontal plane. The motion of this linkage thus provides yaw rotation of the trailer 20 relative to the vehicle. The fourth bar 8 is shorter than the first bar (formed by the body of the trailer 20), such that the instantaneous centre of rotation of the trailer 20 about the vehicle in yaw (being the virtual yaw pivot Y), at least when the vehicle and the trailer are travelling straight ahead, is forward of the vehicle-trailer coupling, and specifically is forward of the vertical centreline X of the vehicle-trailer coupling, as will now be described with reference to FIG. 1.

In FIG. 1, a vehicle coupling 1a is shown mated with a trailer coupling 1b to form a vehicle-trailer coupling with a vertical centreline X, in this instance shown as being equi-spaced by a distance Z through the head of vehicle coupling 1a. A pin 31 retains rigidly the vehicle coupling 1a and the trailer coupling 1b, which can be decoupled by an operator pulling on the knob 30 against the influence of a spring 32.

In this embodiment, a switchable yaw pivot is in the form of a pivot pin 2 which allows a block 3 (which is one part of the apparatus) to pivot in yaw relative to the trailer coupling 1b (being another part of the apparatus) when the pin 4 is disengaged from it. This can be done by the operator pulling downwards on the knob 5 against the influence of a spring 6. Further, the block 3 has a pin 7 attached to it, with the bar 8 (being the fourth bar in the four-bar linkage) attached to the pin 7 such that it can rotate about it substantially in roll (roll pivot).

The switchable yaw pivot in this embodiment is thus a pinned joint that allows motion only about the yaw axis and incorporates a mechanism which can be used to lock the relative yaw motion, thereby forming the switchable yaw pivot. The vehicle side of the switchable yaw pivot is rigidly connected to the trailer coupling 1b. When unlocked, it facilitates yaw alignment between the vehicle coupling 1a and the trailer coupling 1b. When the yaw pivot is locked, there will be rigidity in all six degrees of freedom between block 3 and trailer coupling 1b.

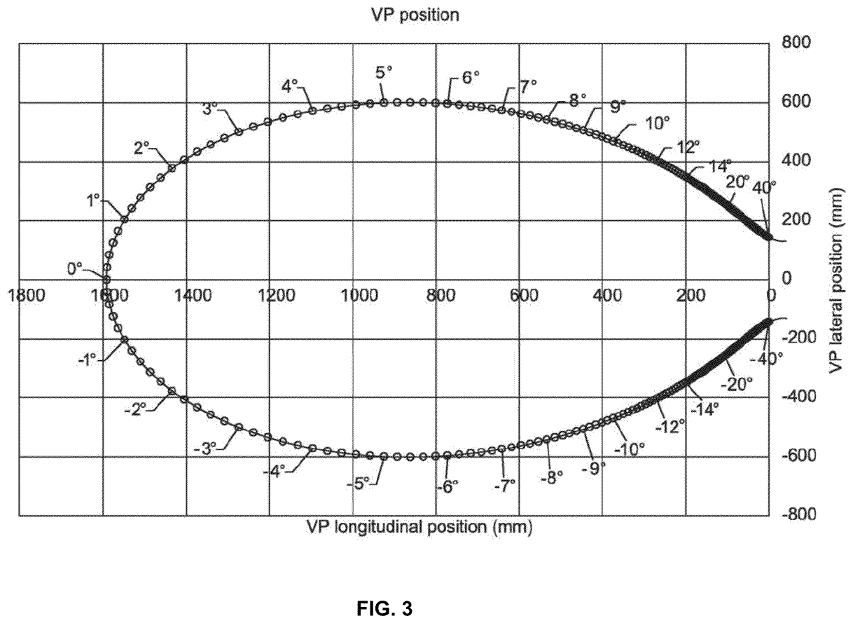

The graph in FIG. 3 shows the position of a virtual yaw pivot in plan view with varying yaw angle. The origin (0,0 position) is the midpoint of the rear bar (i.e. midpoint of pivots 12 and 15) in a four-bar linkage of the general form, though not necessarily the exact geometry or relative dimensions, described above with reference to FIGS. 1 and 2. Thus the precise shape of the curve of FIG. 3 is dependent on the specific geometry of the linkage, relative dimensions of the bars, and location of the pivot points.

It can be seen that as the yaw angle deviates from zero (straight ahead position), the virtual yaw pivot position (Y in FIG. 1) moves rearwards and laterally. At the zero yaw angle position the virtual yaw pivot is 1590 mm forward of the origin, straight ahead. The vertical centreline (X in FIG. 1) of the vehicle-trailer coupling is at approximately 620 mm on the y axis. Therefore, at the straight-ahead position (zero yaw angle, and thus when the vehicle and trailer are aligned) the virtual yaw pivot is about 970 mm forward of the centreline X. It can be seen that when the yaw angle exceeds a relatively small angle such as approximately 7 degrees (though this can vary depending on the geometry of the mechanical linkage), the virtual yaw pivot will actually have moved back to the centreline X and, with further increases in yaw angle, eventually rearwards of that centreline.

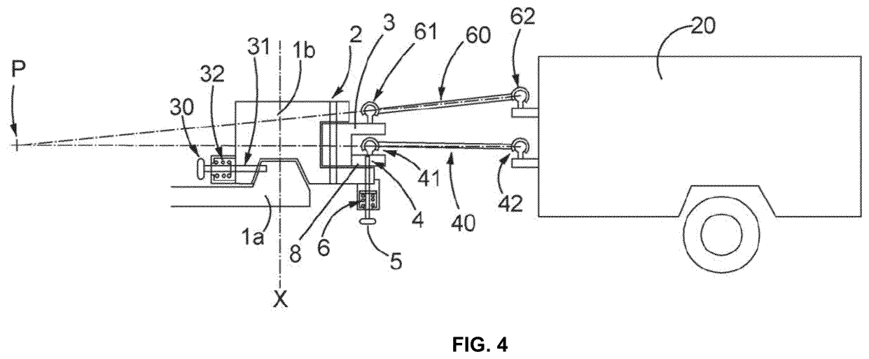

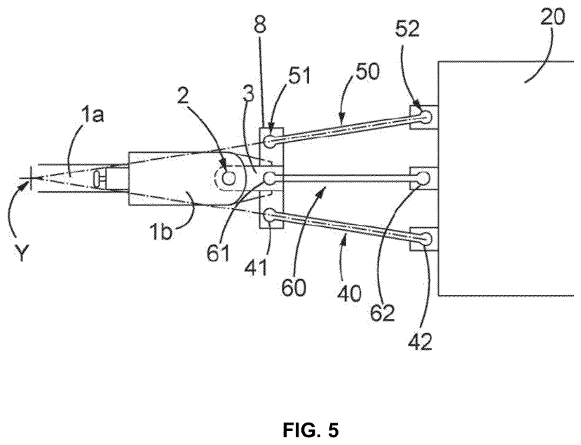

With reference to FIGS. 4 and 5, in a second embodiment of the apparatus the mechanical linkage is formed with five bars. However, as explained this mechanical linkage may be viewed as comprising two four-bar linkages. A first bar of the mechanical linkage is again formed by the body of the trailer 20. The second and third bars (40,50) are connected to it via ball joints (42,52) that provide relative motion in all three degrees of rotational freedom. The other ends of these bars are connected to the fourth bar 8 via ball joints (41,51), providing relative motion in all three degrees of rotational freedom. The second and third bars (40,50) are of equal length and arranged symmetrically about the fore-aft centreline when the vehicle (not shown) and the trailer 20 are travelling straight ahead.

The second and third bars (40,50) lie in substantially the horizontal plane and motion of this linkage provides yaw rotation of the trailer 20 relative to the vehicle. The fourth bar 8 is shorter than the first bar (formed by the body of the trailer 20), such that the instantaneous centre of rotation (the virtual yaw pivot) of the trailer about the vehicle in yaw, at least when the vehicle and the trailer are travelling straight ahead, is forward of the same vertical centreline X of the vehicle-trailer coupling. In straight-ahead operation, as shown in FIG. 5, the virtual yaw pivot is at point “Y” which is at the intersection point of bars 40 and 50. The first, second, third and fourth bars 20, 8, 40 and 50 respectively constitute a first four-bar linkage.

An additional bar, being a fifth bar 60, also with a ball joint (61,62) at each end, is mounted between the first and fourth bars but displaced vertically from the second and third bars (40,50) as can best be seen in FIG. 4. In this embodiment the bars 8, 60 and 20, constitute three bars, and the bars 40 and 50 acting together constitute a fourth bar; so that this ensemble of bars effectively provides a second four-bar linkage lying in substantially the vertical fore-aft plane. This linkage is comprised of this fifth bar 60, which has on its opposing side the second and third bars (40,50), effectively acting as a single bar, and the first and fourth bars. This vertical four-bar linkage provides relative pitch motion between the vehicle and the trailer, and thereby comprises the pitch pivot. In level operation, as shown in FIG. 4, the instantaneous centre of rotation in pitch is at point “P” which is at the intersection point of bar 60 and the plane containing bars 40 and 50.

In this embodiment, it will be appreciated that the three connecting bars with ball joints at each end also provide roll motion between the vehicle and the trailer as these bars can allow the first and fourth bars to twist relative to each other and thereby comprise the roll pivot. In this respect, the roll pivot is associated with both four-bar linkages as the five bars that comprise the two linkages also comprise the roll pivot.

In one embodiment, the pitch pivot provides pitch motion of the trailer relative to the vehicle with the pitch pivot P also located forward of the vertical centreline X of the vehicle-trailer coupling as shown in FIG. 4. This means that the instantaneous centre of pitch motion (the pitch pivot P) lies forward of the coupling at least during typical operating conditions, such as the vehicle and trailer combination proceeding along a flat road. The pitch pivot may move rearwards significantly in more unusual circumstances, such as manoeuvring over uneven ground.

Finally with reference to this second embodiment, the fourth bar 8 is attached to a coupling 1b via a pivot pin 2 and block 3 that allows motion only about the yaw axis and incorporates a mechanism which can be used to lock the relative yaw motion, thereby forming a switchable yaw pivot, such as when pin 4 is disengaged from the fourth bar 8. This can be done by an operator pulling downwards on the knob 5 against the influence of the spring 6. It should be noted that the bar 8 is rigidly connected to the block 3 which in turn is pivotally connected to the coupling 1b by the pivot pin 2. Thus, in some embodiments the bar 8 and block 3 may be considered to effectively be a one-piece structure.

When unlocked, pivot pin 2 facilitates yaw alignment of the vehicle coupling 1a and the trailer coupling 1b. When the yaw pivot is locked, rigidity is provided in all six degrees of freedom.

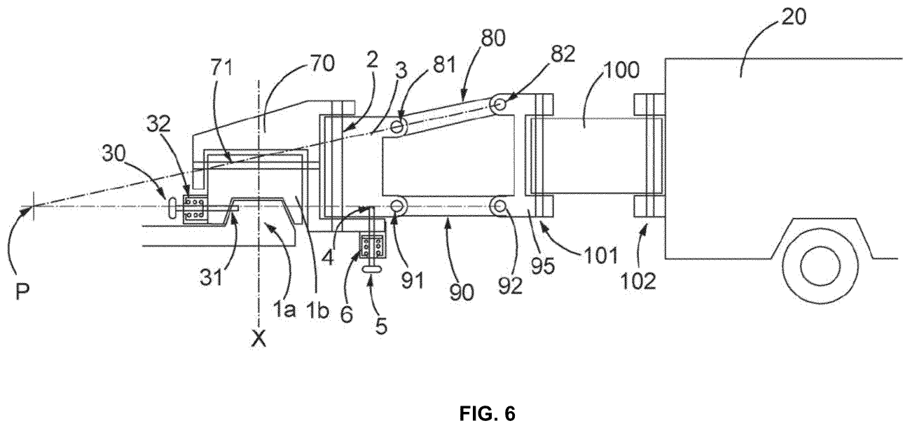

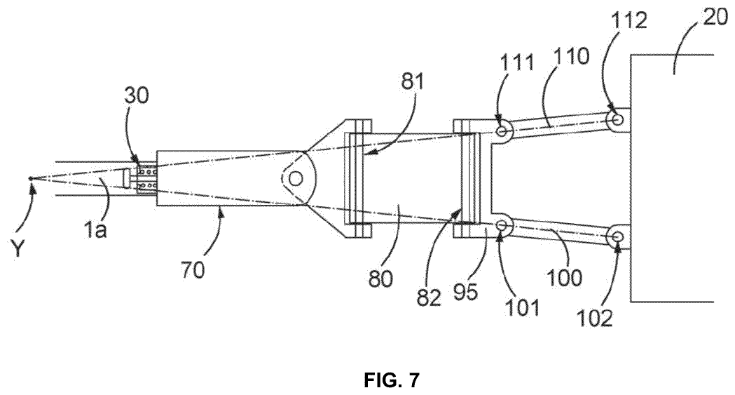

With reference to FIGS. 6 and 7, in a third embodiment of the disclosed apparatus the mechanical linkage has a plurality of bars which may be considered as two four-bar linkages. The first bar of a first of the two four-bar linkages is again formed by the body of the trailer 20. The second and third bars (100,110) are connected to the first bar via pinned joints (102,112) that provide for relative motion only about a vertical axis. The other ends of these bars (100,110) are connected to the fourth bar 95 via pinned joints (101,111), also providing only relative motion about a vertical axis.

An additional two bars projecting forwards (being fifth and sixth bars (80,90)) connect to the fourth bar 95 via pinned joints (82,92) that provide for relative motion about only the transverse horizontal axis. At their forward end, the fifth and sixth bars (80,90) connect to a seventh bar (in the form of block 3 in FIG. 6, i.e., the block 3 and the bar 8 of previous embodiments are integrated in this embodiment into a single structure), again via pinned joints (81,91) having substantially transverse horizontal axes.

The fourth, fifth, sixth and seventh bars (95,80,90,3) of the mechanical linkage form the second four-bar linkage lying in substantially the vertical plane and provide a pitch pivot providing pitch motion of the trailer 20 relative to the vehicle, with the pitch pivot located forward of the vertical centreline X of the vehicle-trailer coupling. This means that the instantaneous centre of pitch motion P (seen in FIG. 6) lies forward of the coupling during typical operating conditions such as the vehicle and trailer proceeding along a flat road. This instantaneous pitch centre P may move rearwards significantly in more unusual circumstances, such as manoeuvring over uneven ground.

In this embodiment, the first four-bar linkage, comprised of the first to fourth bars, and lying in substantially the horizontal plane, provides relative yaw motion of the trailer relative to the vehicle with the instantaneous yaw centre Y being forward of the same vertical centreline X of the vehicle-trailer coupling during typical operating conditions such as the vehicle and trailer proceeding straight along a straight road. However, and as explained above with respect to FIG. 3, it will be appreciated that the instantaneous yaw centre Y may move rearwards significantly in more unusual circumstances, such as manoeuvring around a sharp corner, where the yaw angle is high.

In this embodiment, the seventh bar 3 is rigidly attached to a structural member 70 via a pinned joint 2 (see in FIG. 6) that allows motion only about the yaw axis and incorporates a mechanism which can be used to lock the relative yaw motion, thereby forming the switchable yaw pivot. This occurs when pin 4 is engaged with the seventh bar 3. The pivot lock can be disengaged by an operator pulling downwards on the knob 5 against the influence of the spring 6.

This structural member 70 in turn is attached via a pinned joint 71 to the trailer coupling 1b, the pinned joint 71 aligned in the roll axis, thereby forming a roll pivot. The trailer coupling 1b is detachable, such as being decoupled by an operator pulling on the knob 30 to retract pin 31 against the influence of the spring 32, but when attached to the vehicle coupling 1a they are rigidly joined.

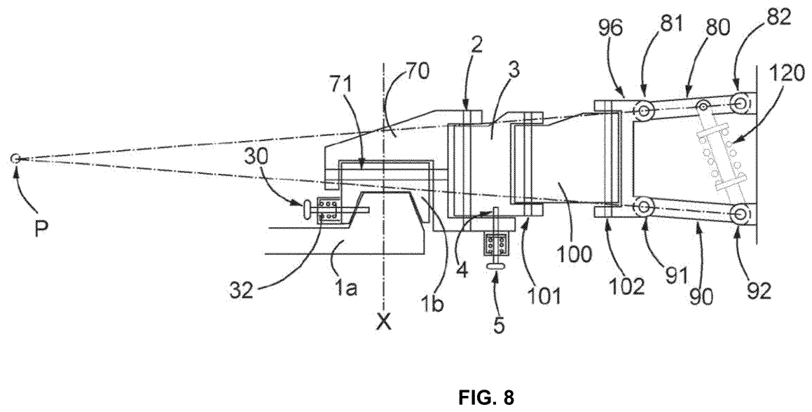

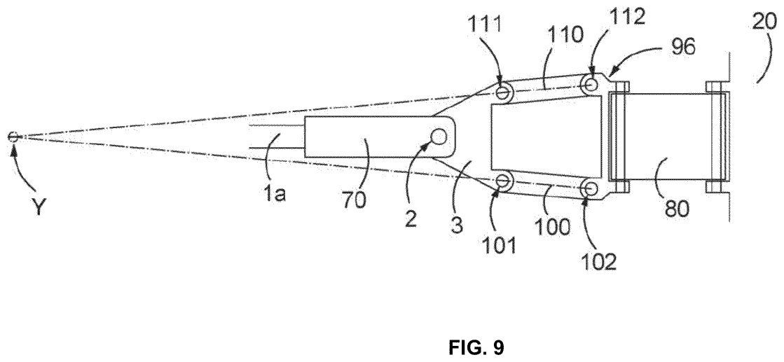

A fourth embodiment is illustrated in FIGS. 8 to 11. With particular reference to FIGS. 8 and 9, the vehicle coupling 1a once again mates with the trailer coupling 1b to form the vehicle-trailer coupling, having the same vertical centreline X as illustrated in earlier FIGS., and the pin 31 retains the trailer coupling 1b to the vehicle coupling 1a rigidly. Decoupling can occur by an operator pulling on the knob 30 against the influence of the spring 32.

The structural member 70 is free to rotate about the trailer coupling 1b substantially in roll about the pin 71, which forms a roll pivot. The switchable yaw pivot includes the pivot pin 2 which allows the block 3 to pivot in yaw relative to the structural member 70 and the trailer coupling 1b when the pin 4 is disengaged therefrom. This can once again be done by an operator pulling downwards on the knob 5 against the influence of the spring 6.

The block 3 is connected to two bars (100,110) via two pins (101,111) respectively. The other ends of the two bars (100, 110) are connected to the block 96. In this form, the two blocks (3,96) and the two bars (100,110) form a four-bar linkage (which can be referred to as the yaw four-bar linkage), which allows the trailer 20 to rotate in yaw relative to the vehicle. In straight-ahead operation with the switchable yaw pivot locked (pin 4 engaged), as shown, the instantaneous centre of yaw rotation is at the intersection point of the two bars (100,110), forming the virtual yaw pivot Y which is at a point forward of the vertical centreline X of the vehicle-trailer coupling.

The block 96 is also connected to two bars (80,90) via two pins (81,91) respectively. At their other ends, the bars 80 and 90 are joined to the trailer 20 via two pins (82,92). In this form, the block 96, the bars (80,90) and the trailer 20 comprise a second four-bar linkage, being the four-bar linkage that provides pitch rotation of the trailer 20 relative to the vehicle (not shown), which can be referred to as the pitch four-bar linkage.

Also illustrated in FIG. 8 is an example of the inclusion of a load compensating spring adapted to carry the weight of the portion of the apparatus forward of the pitch pivot, to obviate the need for the user that is connecting the couplings to have to lift the weight of this portion of the apparatus to raise it to the level of the vehicle coupling. FIG. 8 shows a compression spring 120 that supports the bar 80, thereby holding the trailer coupling 1b at an appropriate height to facilitate ease of coupling to the vehicle coupling 1a.

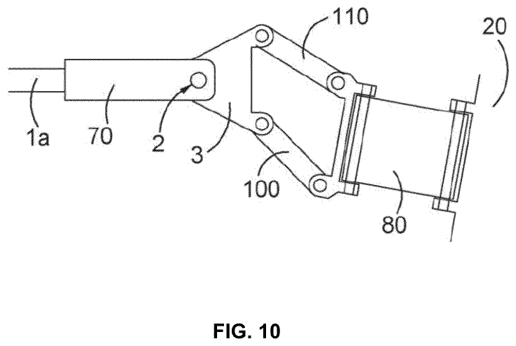

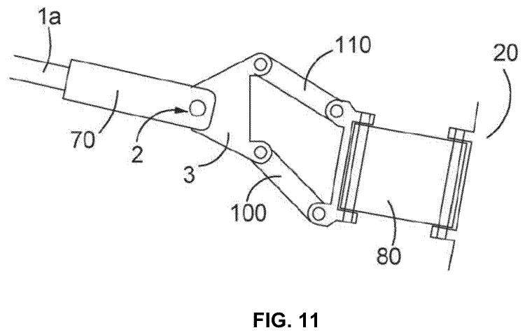

In relation to this fourth embodiment, FIG. 10 shows an embodiment the apparatus when a vehicle and trailer are turning a corner to the left, where the yaw four-bar linkage is in a position to provide yaw rotation of the trailer 20 relative to the vehicle. FIG. 11 then shows the switchable yaw pivot disengaged. This figure shows the vehicle coupling 1a aligned with the trailer 20 direction of travel, and with the yaw four-bar linkage set to a yaw angle. This position of the apparatus may be required to successfully couple the vehicle to the trailer when they are both pointing in the same direction but with a small lateral offset.

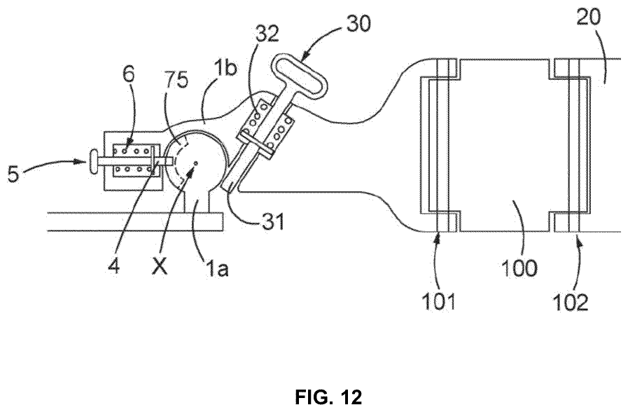

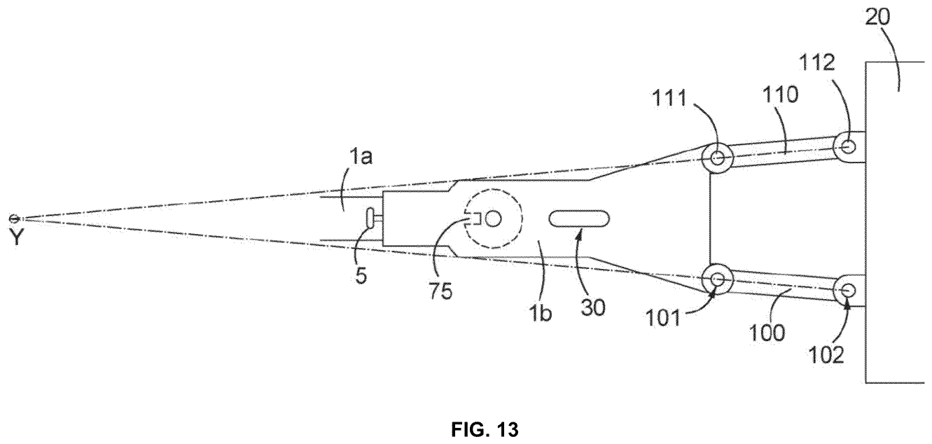

Illustrated in FIGS. 12 and 13 is a fifth embodiment of the apparatus, being an embodiment in which the switchable yaw pivot is incorporated in the coupling, as are the roll and pitch pivots.

In this embodiment, the vehicle coupling 1a again mates with the trailer coupling 1b, with the pin 31 retaining the trailer coupling 1b to the vehicle coupling 1a. Decoupling can again occur with an operator pulling on the knob 30 against the influence of the spring 32.

The vehicle coupling 1a includes a spherical ball with a circumferential groove 75, with a pin 4 engaging with the groove 75. The vertical centreline of the vehicle-trailer coupling will pass through the centre of the spherical ball. When engaged, yaw rotation between the trailer coupling 1b and the vehicle coupling 1a is prevented. When the pin 4 is disengaged from the groove 75, the switchable yaw pivot is unlocked. This can be done by an operator pulling on the knob 5 against the influence of the spring 6.

The pin 4 has a round cross section so that the trailer coupling 1b may rotate relative to the vehicle coupling 1a in roll (roll pivot), and the pin 4 is free to travel along the groove 75, thus enabling the trailer 20 to rotate about the vehicle (not shown) in pitch (pitch pivot).

In this embodiment, the trailer coupling 1b is shown connected to two bars (100,110) via two pins (101,111) respectively. The other end of these two bars (100,110) are connected to the trailer 20 via two pins (102,112) respectively, with the trailer coupling 1b, the two bars (100,110) and the trailer 20 forming a four-bar linkage which allows the trailer 20 to rotate in yaw relative to the vehicle. In straight-ahead operation with the switchable yaw pivot locked (namely, with the pin 4 engaged), as shown, the instantaneous centre of yaw rotation (the virtual yaw pivot Y) is at the intersection point of the two bars (100,110) which is at a point forward of the vertical centreline X (through the spherical ball of the vehicle coupling 1a) of the coupling.

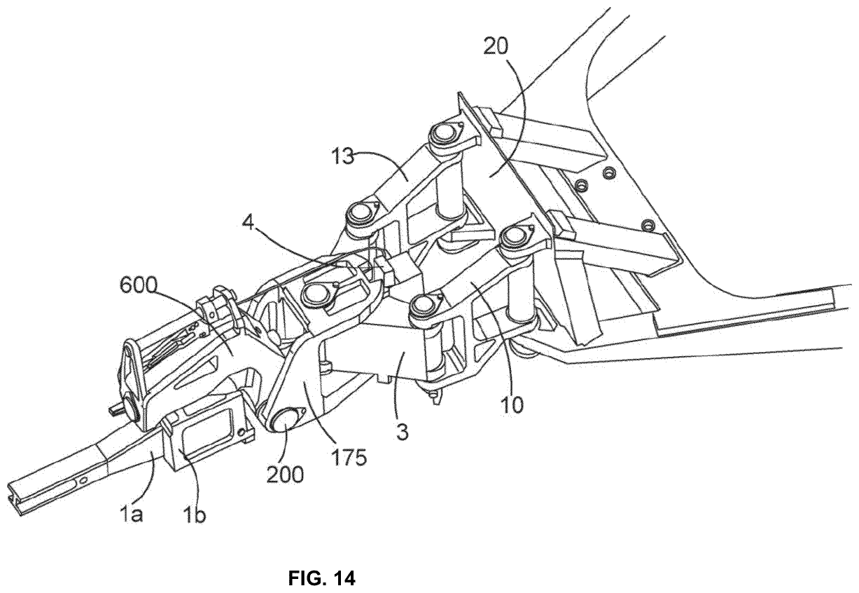

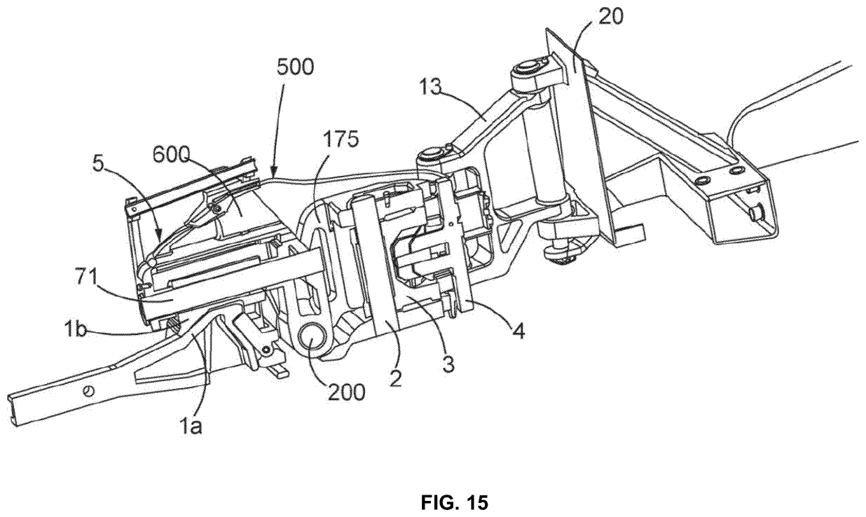

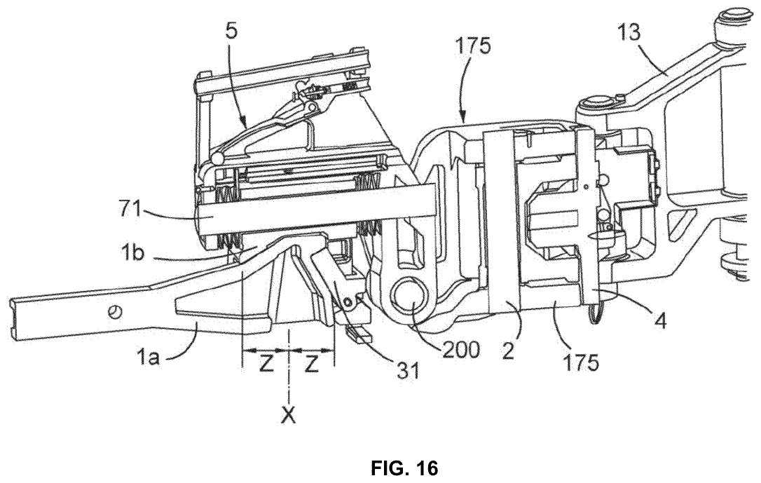

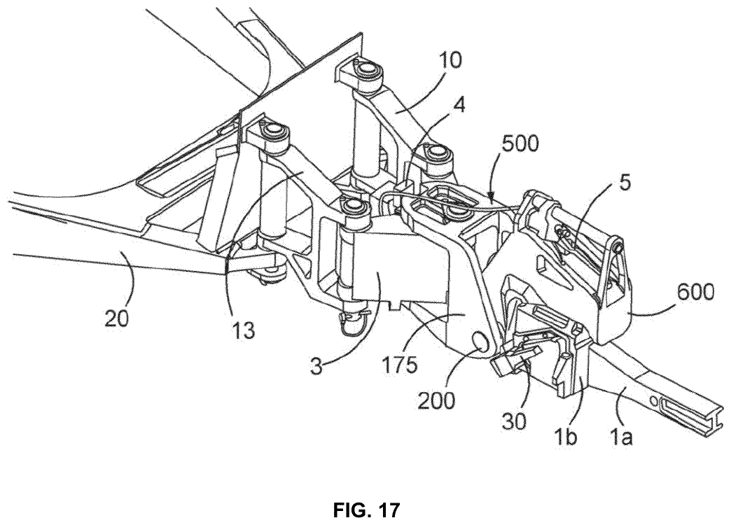

A sixth embodiment is illustrated in FIGS. 14, 15, 16, 17 and 18, where a vehicle coupling 1a connects to a trailer coupling 1b when a trailer is connected to a vehicle, with the vehicle-trailer coupling having a vertical centreline X again located equi-spaced by a distance Z in the head portion of the vehicle coupling 1a (see FIG. 16). A latch 31 holds the two together and a lever 30 can be used to release the latch 31 for decoupling.

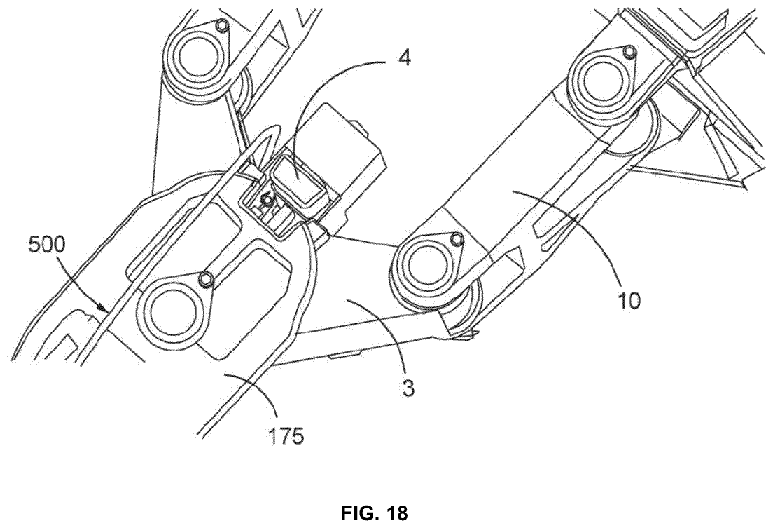

The trailer coupling 1b is connected to a housing 600 via a pin 71. The pin 71 provides the roll pivot. The housing 600 is joined to another housing 175 via another pin 200, which pin provides the pitch pivot. A bar 3 is connected to the housing 175 via another pin 2 and can be constrained from rotating about the pin 2 by a latch 4. The pin 2, the bar 3 and the latch 4 (shown latched in FIG. 16 and unlatched in FIG. 18) together constitute the switchable yaw pivot, with the switching being done via a handle 5. In this respect, pulling on the handle 5 unlatches the latch 4 via a cable 500 or other suitable link, thereby allowing the bar 3 to rotate relative to the housing 175.

In this embodiment, the bars 10 and 13 connect the bar 3 to the trailer 20, forming a four-bar linkage with a virtual yaw pivot for the trailer 20 at a point forward of vertical centreline X when the vehicle and trailer are travelling straight ahead.

A person skilled in the art will understand that there may be variations and modifications other than those specifically described. It is to be understood that the invention includes all such variations and modifications.

1. Apparatus for connecting a trailer to a vehicle for towing, the apparatus comprising:
a) a vehicle-trailer coupling including a vehicle coupling and a trailer coupling and having a vertical centreline wherein the vehicle-trailer coupling provides no relative motion at all, but is locked in all six degrees of freedom;
b) a mechanical linkage that generates a virtual yaw pivot and that is configured to permit relative movement between the vehicle and the trailer about at least a yaw axis; and
c) a switchable yaw pivot;
wherein the mechanical linkage is configured to constrain the location of the virtual yaw pivot to be, in use, at or forward of the vertical centreline of the vehicle-trailer coupling, at least for small yaw angles; and
wherein the switchable yaw pivot is switchable between an unlocked position, where movement in yaw of one part of the apparatus relative to a remaining part of the apparatus about the switchable yaw pivot is permitted, and a locked position, where movement of the one part of the apparatus relative to the remaining part of the apparatus about the switchable yaw pivot is not permitted.

2. Apparatus according to claim 1, wherein the vehicle has a rear face which is a vertical plane coincident with a rearmost extremity of the vehicle, and the location of the virtual yaw pivot is at or forward of a rear face of the vehicle at small yaw angles.

3. Apparatus according to claim 1, wherein the mechanical linkage includes a bar connected to the trailer and two connecting bars, the mechanical linkage being configured to constrain the location of the virtual yaw pivot to be, in use, at or forward of the vehicle-trailer coupling at small yaw angles.

4. Apparatus according to claim 1, including a pitch pivot for providing relative movement between the vehicle and the trailer about a pitch axis wherein the pitch pivot provides for relative movement between the vehicle and the trailer about the pitch axis by allowing a bar of the mechanical linkage to rotate in pitch relative to the vehicle.

5. Apparatus according to claim 1, including a pitch pivot for providing relative movement between the vehicle and the trailer about a pitch axis wherein the pitch pivot provides for relative movement between the vehicle and the trailer about the pitch axis by allowing a bar of the mechanical linkage to rotate in pitch relative to the trailer.

6. Apparatus according to claim 1, including a pitch pivot for providing relative movement between the vehicle and the trailer about a pitch axis wherein the pitch pivot provides for relative movement between the vehicle and the trailer about the pitch axis by the mechanical linkage incorporating two or more ball joints.

7. Apparatus according to claim 1, including a roll pivot for relative movement between the vehicle and the trailer about a roll axis wherein the roll pivot provides for relative movement between the vehicle and the trailer about the roll axis by allowing the mechanical linkage to rotate about the roll axis relative to the vehicle.

8. Apparatus according to claim 4, wherein the mechanical linkage comprises a first four bar linkage and a second four bar linkage and wherein the pitch pivot provides for relative movement between the vehicle and the trailer about the pitch axis by use of the second four-bar linkage, arranged such that its bars lie in a substantially vertical fore-aft plane, wherein the second four-bar-linkage includes the pitch pivot.

9. Apparatus according to claim 8, wherein a roll pivot provides for relative movement between the vehicle and the trailer about a roll axis by both the first and second four-bar linkages incorporating ball joints at all joints.

10. Apparatus according to claim 8 wherein the first four-bar linkage is a yaw four-bar linkage, which allows the trailer to rotate in yaw relative to the vehicle, and wherein, in straight-ahead operation with the switchable yaw pivot locked, the instantaneous centre of yaw rotation is at a point forward of the vehicle-trailer coupling.

11. Apparatus according to claim 8, wherein the second four-bar linkage is a pitch four-bar linkage, which provides pitch rotation of the trailer relative to the vehicle.

12. Apparatus according to claim 1, wherein the switchable yaw pivot is arranged to switch to the locked state automatically on the vehicle pulling the trailer into a straight-ahead direction aligning the trailer with the vehicle.

13. Apparatus according to claim 12, wherein the switchable yaw pivot must be held in its unlocked position by a person and will, under the influence of a spring or the like, revert to the locked position as soon released by the person and the vehicle is aligned with the trailer.

14. Apparatus according to claim 1 wherein the switchable yaw pivot includes: a block coupled to or forming part of the mechanical linkage and a pivot pin pivotally coupling the block to the vehicle-trailer coupling; and a locking mechanism for releasably locking the block from movement about the pivot pin relative to vehicle-trailer coupling.
